(19) United States
(12) Patent Application Publication
(10) Pub. No.: US 2014/0006511 A1
(43) Pub. Date: Jan. 2, 2014

(54) METHOD AND APPARATUS FOR SHARING A FILE IN P2P SYSTEM

(71) Applicant: Samsung Electronics Co., Ltd., Gyeonggi-do (KR)

(72) Inventors: Marcin GOLISZEWSKI, Warsaw (PL); Maciej Marek Lipinski, Warsaw (PL)

(21) Appl. No.: 13/933,850

(22) Filed: Jul. 2, 2013

(30) Foreign Application Priority Data
Jul. 2, 2012 (KR) 10-2012-0071911

(51) Int. Cl. H04L 29/08

(52) U.S. Cl. CPC H04L 67/06
USPC 709/204

(57) ABSTRACT

A method and an apparatus for sharing a file with at least one peer terminal by a terminal in a Peer-to-Peer (P2P) network are provided. The method includes dividing a file allowed to be shared and generating two or more fragment files; generating file division information used for reconstructing the file allowed to be shared by using the fragment files; combining the file division information with each of the fragment files; and transmitting the combined file division information and fragment files to the at least one terminal.

### PRIORITY

This application claims priority under 35 U.S.C. §119(a) to Korean Application Serial No. 10-2012-0071911, which was filed in the Korean Intellectual Property Office on Jul. 2, 2012, the entire content of which is hereby incorporated by reference.

### BACKGROUND OF THE INVENTION

1. Field of the Invention

The present invention relates generally to a method and an apparatus for sharing a file, and more particularly, to a method and an apparatus for sharing a file in a Peer-to-Peer (P2P) system.

2. Description of the Related Art

A P2P system is a technique for directly connecting entities and sharing desired content over the Internet. That is, the P2P system directly connects personal terminals and transmits a file beyond concepts of conventional server and client or concepts of a supplier and a consumer.

In the conventional P2P system, a user terminal making a request for transmission of a particular file has to make a request for transmission of the particular file from a peer terminal, and the peer terminal having received the request searches whether the peer terminal itself has the corresponding file and then transmits the corresponding file to the terminal having made the request. That is, in the conventional P2P system, the user terminal and the peer terminal have to make a lot of effort to share the file.

In order to enable the user terminal to make the request for transmission of the file from the peer terminal, the user terminal and the peer terminal should be located in a local network. Accordingly, file sharing between terminals in the conventional P2P system is limited to the local network. When the peer terminal moves to another network, the user terminal can no longer download the particular file.

### SUMMARY OF THE INVENTION

Accordingly, the present invention has been made to address at least the problems and disadvantages described above and to provide at least the advantages described below. Accordingly, an aspect of the present invention provides a method of actively sharing a file by which file sharing is achieved without intervention of a user. Further, an aspect of the present invention provides a method of sharing a file by which file sharing is achieved between different networks. Other aspects of the present invention will be grasped through the following embodiments.

In accordance with an aspect of the present invention, a method of sharing a file between terminals in a Peer to Peer (P2P) network is provided. The method includes dividing a file allowed to be shared and generating two or more fragment files; generating file division information used for reconstructing the file allowed to be shared by using the fragment files; and combining the file division information with each of the fragment files and transmitting the combined file division information and fragment files to one or more peer terminals.

In accordance with another aspect of the present invention, a method of sharing a file between terminals in a Peer to Peer (P2P) network is provided. The method includes receiving one or more fragment files generated by dividing a file allowed to be shared into two or more fragment files from a peer terminal; and when a network is changed, transmitting the received one or more fragment files to one or more peer terminals located on the changed network.

In accordance with another aspect of the present invention, an apparatus for sharing a file between terminals in a Peer to Peer (P2P) network is provided. The apparatus includes a controller for dividing a file allowed to be shared, generating two or more fragment files, generating file division information used for reconstructing the file allowed to be shared by using the fragment files, and combining the file division information with each of the fragment files; and a transceiver for transmitting the combined fragment files with the file division information to one or more peer terminals.

In accordance with another aspect of the present invention, an apparatus for sharing a file between terminals in a Peer to Peer (P2P) network is provided. The apparatus includes a transceiver for performing transmission/reception with a peer terminal; and a controller for, when a network is changed after receiving one or more fragment files generated by dividing a file allowed to be shared into two or more fragment files from a peer terminal, transmitting the received one or more fragment files to one or more peer terminals located on the changed network.

### BRIEF DESCRIPTION OF THE DRAWINGS

The above and other features, aspects, and advantages of the present invention will be more apparent from the following detailed description taken in conjunction with the accompanying drawings, in which:

FIG. 1 illustrates an example of a file sharing method according to embodiments of the present invention;

FIG. 2 is a flowchart describing a file sharing process from a viewpoint of a terminal generating a fragment file according to an embodiment of the present invention;

FIG. 3 illustrates an example of file division information according to an embodiment of the present invention;

FIG. 4 is a flowchart describing a file sharing process from a viewpoint of a terminal relaying a received fragment file according to an embodiment of the present invention;

FIG. 5 is a flowchart describing a file sharing process from a viewpoint of a terminal making a request for transmission of a fragment file according to an embodiment of the present invention;

FIG. 6 is a flowchart describing a file sharing process from a viewpoint of a terminal receiving a request for transmission of a fragment file according to an embodiment of the present invention; and

FIG. 7 is a block diagram of a file sharing apparatus according to an embodiment of the present invention.

### DETAILED DESCRIPTION OF EMBODIMENTS OF THE PRESENT INVENTION

In the following description of the present invention, a detailed description of known functions and configurations incorporated herein will be omitted when it may make the subject matter of the present invention unclear.

As described above, according to the conventional file sharing method in a P2P system, file sharing is not achieved without intervention of the user, and file sharing between terminals is not easily achieved in a network having high mobility.

Accordingly, the present invention provides a method of sharing a file without intervention of the user. Further, the present invention provides a method of sharing a file between different networks by enabling the file to be shared by a terminal moving between different networks.

Hereinafter, embodiments of the present invention will be described with reference to the accompanying drawings.

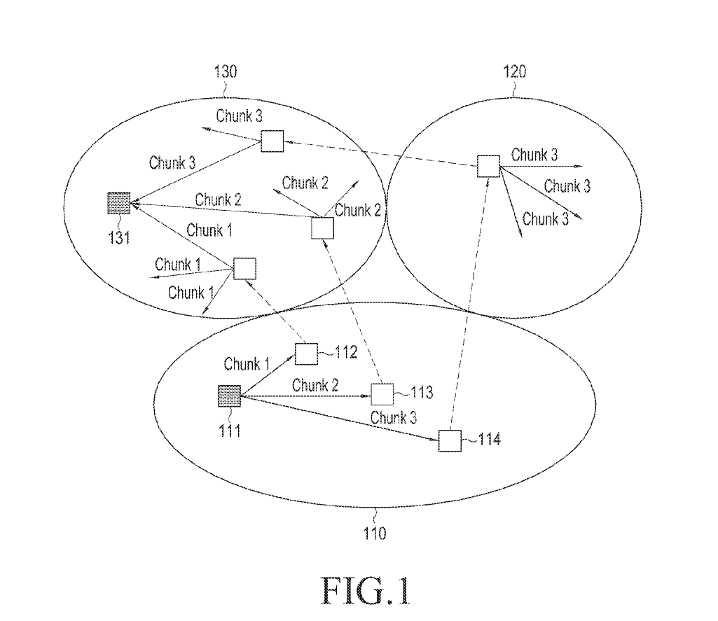

A concept of a file sharing method according to embodiments of the present invention will be described with reference to FIG. 1.

A terminal 111 existing in a network 110 divides a file allowed to be shared into a predetermined number of fragment files, and then transmits fragment files chunk 1, chunk 2, and chunk 3 generated by the division to peer terminals 112, 113, and 114. The transmission of the fragment files is performed without intervention of the user. The file allowed to be shared may be a file existing in a particular directory of the terminal 111.

Thereafter, when the peer terminals 112, 113, and 114 having received one of the fragment files chunk 1, chunk 2, and chunk 3 move to other networks 120 and 130, the peer terminals 112, 113, and 114 having moved to other networks transmit the previously received fragment files to a peer terminal within the corresponding network. The dotted lines of FIG. 1 show movement paths of each terminal. The peer terminals 112, 113, and 114 transmit corresponding fragment files whenever the network is changed, or transmit corresponding fragment files at preset periods.

Meanwhile, the terminal 111 generates file division information used for reconstructing the original file, that is, the file allowed to be shared by using corresponding fragment files, and makes the generated file division information public on the network. The publication may be separately performed from transmission of the fragment files, or may be integratively performed with the fragment files.

Accordingly, when all the fragment files are received, a terminal 131 reconstructs the corresponding fragment files with reference to file division information on the corresponding fragment files.

Meanwhile, at least one of the fragment files may be transmitted at the request of the terminal 131. For example, it is assumed that the fragment file chunk 1 is first received by the terminal 131. At this time, when the terminal determines that the fragment file chunk 1 corresponds to a fragment file divided from the file which the user desires with reference to file division information on the corresponding fragment file, the terminal makes a request for transmission of the remaining fragment files chunk 2 and chunk 3 from the peer terminals 113 and 114, searches for the corresponding fragment file, and then transmits the corresponding fragment file to the terminal 131 when the corresponding fragment file is stored therein.

According to the present invention, there is an advantage of sharing the file between terminals without intervention of the user and sharing the file even between terminals moving between the different networks 110, 120, and 130.

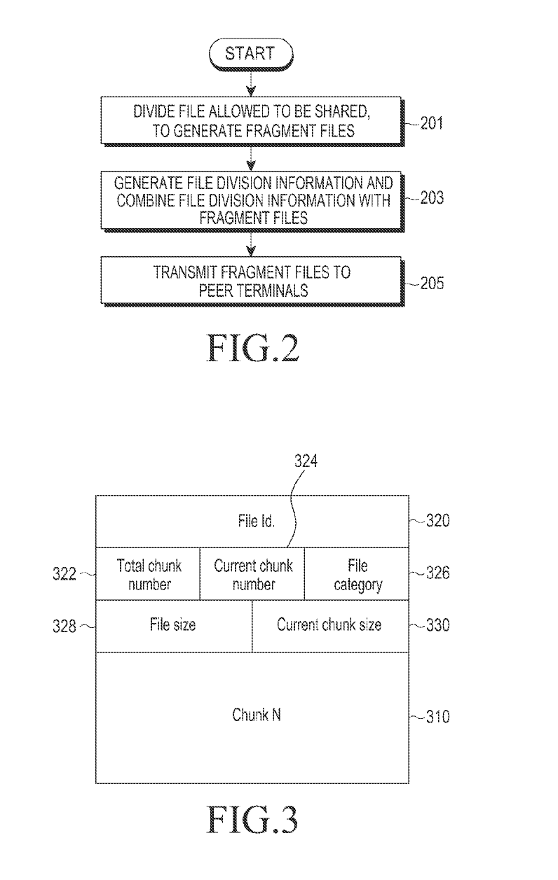

FIG. 2 is a flowchart describing a file sharing process according to an embodiment of the present invention. FIG. 2 illustrates that a file allowed to be shared is divided and then fragment files are generated from a viewpoint of the terminal.

In step 201, the user terminal divides the file allowed to be shared and then generates fragment files. Here, the file allowed to be shared refers to a file allowed to be transmitted to the peer terminal The file allowed to be shared may be a file located within a particular directory or a file separately designated by the user.

In dividing the file allowed to be shared, the user terminal may divide the file allowed to be shared based on the number of peer terminals. For example, when the number of peer terminals is three, the user terminal may divide the file allowed to be shared into three files. The number of files to be divided from the file allowed to be shared varies depending on a setting.

In step 203, the user terminal generates file division information. The file division information refers to information used for reconstructing the original file, that is, the file allowed to be shared by using the fragment files generated in step 201. In an embodiment of the present invention, when the file division information is generated, the user terminal combines the generated file division information with each of the fragment files. An example of the file division information will be described with reference to FIG. 3.

As shown in FIG. 3, according to an embodiment of the present invention, the file division information combined with each fragment file 310 (chunk N) contains information indicating the file from which the corresponding fragment file 310 is divided, that is, file identification information 320. Also, the file division information combined with each fragment file 310 contains information 322 indicating a total number of fragment files divided from the corresponding file and information 324 indicating an ordinal number of the corresponding fragment file. According to the embodiment, the file division information combined with each fragment file 310 may contain at least one of category information 326 indicating the category to which the corresponding file belongs, information 328 on a size of the corresponding file, and information 330 on a size of the corresponding fragment file.

Referring back to FIG. 2, in step 205, the user terminal transmits each fragment file combined with the file division information to the peer terminals. At this time, the user terminal can transmit one fragment file to one peer terminal. For example, when the file allowed to be shared is divided in to three files and a first fragment file, a second fragment file, and a third fragment file are generated, the user terminal can transmit the first fragment file to a peer terminal A, the second fragment file to a peer terminal B, and the third fragment file to a peer terminal C.

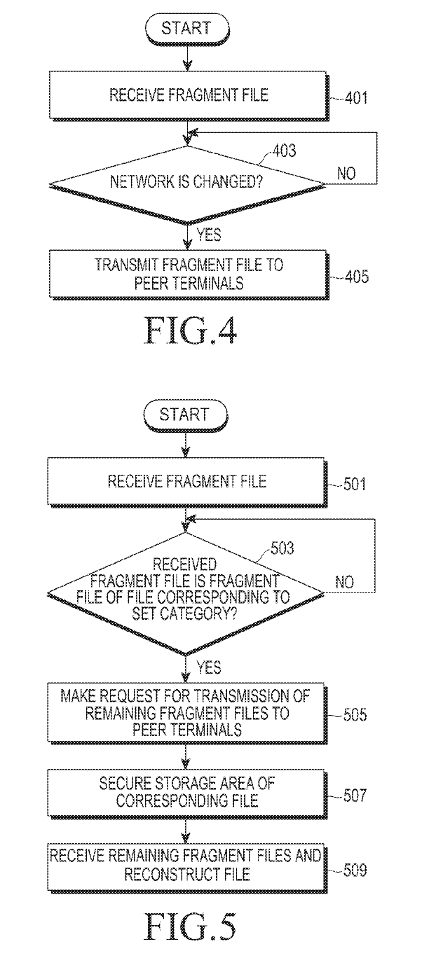

FIG. 4 is a flowchart describing the file sharing process according to an embodiment of the present invention. FIG. 4 illustrates that the fragment file is received and relayed from the viewpoint of the terminal.

When the fragment file is received in step 401, the user terminal stores the corresponding fragment file in a set area, and then proceeds to step 403. Here, storing the corresponding fragment file in the set area means storing the corresponding fragment file such that the corresponding fragment file is allowed to be shared with peer terminals. For example, it means storing the corresponding fragment file such that transmission of the corresponding fragment file is automatically performed when an event such as a network change occurs or when there is a transmission request from another peer terminal.

The user terminal determines whether the network is changed in step 403, and proceeds to step 405 when the network is changed. Here, the network change means, for example, a case where the user terminal moves from one Wi-Fi network to another Wi-Fi network, moves from one Wi-Fi network to one ad-hoc network, or moves from one ad-hoc network to another ad-hoc network.

In step 405, the user terminal transmits the fragment file received in step 401, that is, the fragment file allowed to be shared to peer terminals existing on the changed network.

FIG. 5 is a flowchart for describing a file sharing method of making a request for transmission of a fragment file from the viewpoint of the terminal according to an embodiment of the present invention. As described in FIG. 5, the user can more quickly transmit the corresponding file with a priority by designating the file corresponding to a particular category.

When the fragment file is received in step 501, the user terminal proceeds to step 503. In step 503, the user terminal determines whether the received fragment file is a fragment file of the file corresponding to a set category. The set category refers to a category preferred by the user, that is, a category designated by the user, such as a category related to a movie or music. The user terminal refers to file division information combined with the received fragment file in order to determine whether the received fragment file is a fragment file of the file corresponding to the set category. As described above with reference to FIG. 3, the file division information may further contain category information of the corresponding fragment file. Accordingly, the user terminal can determine whether the received fragment file is the fragment file of the file corresponding to the set category with reference to the category information among the file division information of the received fragment file. When the received fragment file is the fragment file of the file corresponding to the set category, the user terminal proceeds to step 505.

The user terminal transmits a message requesting transmission of the remaining fragment files of the file including the received fragment file to the peer terminals in step 505, and then proceeds to step 507. The message requesting the transmission of the remaining fragment files may contain identification information for identifying itself on the network, file identification information of the corresponding file, and information indicating an ordinal number of the fragment file requested to be transmitted, as described with reference to FIG. 3.

In step 507, the user terminal secures a storage area for receiving the remaining fragment files. For example, when the remaining fragment files are received but cannot be stored because the user terminal stores fragment files divided from other various files, the user terminal can delete the fragment files divided from other various files. Alternatively, although the user terminal has a sufficient storage area to receive and store the remaining fragment files, the user terminal may secure the storage area for the remaining fragment files in order to prevent a case where the storage area becomes insufficient for storage because fragment files divided from another file are stored before the remaining fragment files are stored. Securing the storage area may be achieved by predicting sizes of the remaining fragment files. For example, as described above with reference to FIG. 3, the file division information may contain information on the size of the corresponding file and information on the size of the corresponding fragment file, so that the user terminal can secure the storage area using such information. In addition, step 507 may be omitted.

In step 509, the user terminal receives the remaining fragment files from another peer terminal and then stores the received remaining fragment files, and reconstructs the file with reference to the file division information. As described above with reference to FIG. 3, the file division information contains the file identification information for identifying the corresponding file, the information indicating the number of fragment files divided from the corresponding file, and the information indicating the ordinal number of the corresponding fragment file, so that the user terminal can reconstruct the original file using such information.

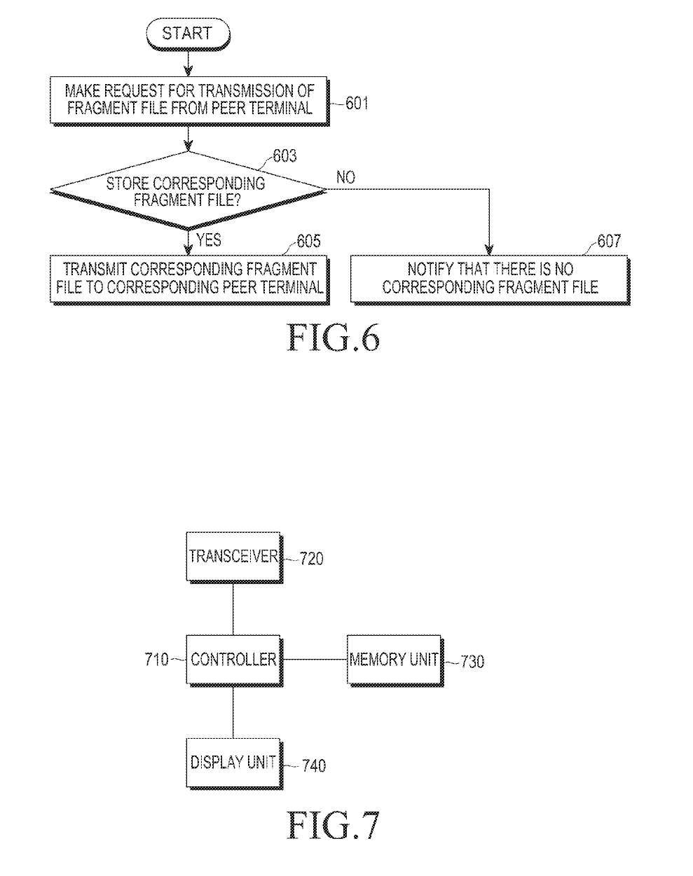

FIG. 6 is a flowchart describing the file sharing method from the viewpoint of the terminal having received the request for the transmission of the fragment file from the peer terminal according to an embodiment of the present invention.

When there is the request for the transmission of the fragment file from the peer terminal in step 601, the user terminal proceeds to step 603. The request for the transmission may contain identification information for identifying the peer terminal on the network and information indicating an ordinal number of the fragment file requested to be transmitted.

The user terminal searches whether the corresponding fragment file is stored in step 603. When the corresponding file is stored, the user terminal proceeds to step 605. Otherwise, the user terminal proceeds to step 607.

In step 605, the user terminal transmits the requested fragment file to the peer terminal having made the request, after determining that the requested fragment file is stored.

Meanwhile, in step 606, the user terminal transmits a message informing that there is no corresponding fragment file to the peer terminal, after determining that the requested fragment file is not stored.

Hereinafter, a method of, when the terminal having made the request for the transmission of the fragment file does not receive some of the fragment files, finding the fragment file which is not received will be described.

When the user terminal does not receive some of the fragment files after making the request for the transmission of the fragment file, the user terminal may use a Distributed Hash Table (DHT) scheme or a Prefix Hash Table (PHT) scheme to find the fragment file which is not received (hereinafter, referred to as a particular fragment file). To this end, it is assumed that all terminals located on the network build and manage a Hash table. A message making a request for transmission of the particular fragment file is transmitted from one terminal to another terminal according to the DHT scheme or the PHT scheme, and accordingly the user terminal can find the terminal storing the particular fragment file. Meanwhile, when the terminals located on the network use a Global Positioning System (GPS), the user terminal can detect a position of the terminal storing the particular fragment file and accordingly guide the user to a receivable position of the particular fragment file. That is, the user terminal receives GPS information of the terminal storing the particular fragment file, detects the position of the corresponding terminal by using the GPS information, and then guides the position of the corresponding terminal to the user.

Further, the user terminal can guide a position where the user was located in the past among receivable positions of the particular fragment file based on a past movement history of the user terminal to the user of the user terminal. To this end, it is assumed that the terminals located on the network periodically store their movement positions.

FIG. 7 is a block diagram describing a file sharing apparatus according to an embodiment of the present invention.

Referring to FIG. 7, the file sharing apparatus according to an embodiment of the present invention includes a controller 710, a transceiver 720, a memory unit 730, and a display unit 740.

The controller 710 divides a file allowed to be shared and generates at least two fragment files. The controller 710 can divide the file allowed to be shared based on the number of peer terminals. Further, the controller 710 generates file division information used for reconstructing the file allowed to be shared by using the divided fragment files, and combines the generated file division information with each of the fragment files.

After receiving one fragment file from the peer terminal, when a network is changed, the controller 710 can transmit the received fragment file to at least one peer terminal located on the changed network.

Furthermore, the controller 710 determines whether the file allowed to be shared belongs to a set category with reference to the file division information combined with the fragment file. When the file allowed to be shared is the file belonging to the set category, the controller 710 transmits a message making a request for transmission of the remaining fragment files divided from the file allowed to be shared to at least one peer terminal At this time, the controller 710 guides a position of another terminal, to the user, based on information on the position of another terminal storing at least one fragment file among the remaining fragment files received from the peer terminal. The guiding may be performed by an image output through the display unit 740. The controller 710 may guide, to the user, a position of another terminal corresponding to its own past position based on past positions stored in the memory unit 730.

The transceiver 720 transmits the fragment files combined with the file division information to the peer terminal, or receives the fragment files from the peer terminal. At this time, the transceiver 720 can transmit one fragment file to one peer terminal.

The memory unit 730 stores the file allowed to be shared or the fragment file to be shared. Also, the memory unit 730 periodically stores its own position.

The above described embodiments of the present invention may be implemented in various ways. For example, the embodiments of the present invention may be implemented by hardware, software, or a combination thereof. In an implementation by software, the embodiments of the present invention may be implemented by software executed on one or more processors using various operating systems or platforms. In addition, such software may be made using any of a plurality of suitable programming languages, and complied by an executable machine language code executed in a framework or a virtual machine or an intermediate code.

Further, when the embodiments of the present invention are executed on one or more processors, the embodiments of the present invention may be implemented by one or more processor-readable media (for example, a memory, a floppy disk, a hard disk, a compact disk, an optical disk, a magnetic tape, or the like) recording one or more programs for performing the method of implementing the above described embodiments of the present invention.

According to the present invention, it is possible to more actively share a file by automatically transmitting the file between terminals without intervention of a user. The present invention may be applied to a terminal moving between different networks, and as a result, has an advantage of sharing the file between different networks.

While the present invention has been shown and described with reference to certain embodiments thereof, it will be understood by those skilled in the art that various changes in form and details may be made therein without departing from the spirit and scope of the present invention. Therefore, the spirit and scope of the present invention is not limited to the described embodiments thereof, but are defined by the appended claims and equivalents thereof.

What is claimed is:

1. A method of sharing a file with at least one peer terminal by a terminal in a Peer-to-Peer (P2P) network, the method comprising:
dividing a file allowed to be shared and generating two or more fragment files;
generating file division information used for reconstructing the file allowed to be shared by using the fragment files;
combining the file division information with each of the fragment files; and
transmitting the combined file division information and fragment files to the at least one terminal.

2. The method of claim 1, wherein the file division information includes at least one of identification information of the file allowed to be shared, information on a number of fragment files, and information indicating an ordinal number of a corresponding fragment file.

3. The method of claim 2, where in the file division information further includes information on a category to which the file allowed to be shared belongs.

4. The method of claim 1, further comprising determining a number of fragment files to be divided from the file allowed to be shared based on a number of the at least one peer terminal,
wherein transmitting the fragment files comprises distributively transmitting the fragment files to the at least one peer terminal, one by one.

5. A method of sharing a file with at least one peer terminal by a terminal in a Peer-to-Peer (P2P) network, the method comprising:
receiving, from a peer terminal, at least one fragment file generated by dividing a file allowed to be shared into two or more fragment files; and
when a network is changed, transmitting the received at least one fragment file to one or more peer terminals located on the changed network.

6. The method of claim 5, further comprising:
after the receiving of the at least one fragment file,
determining whether the file allowed to be shared is a file belonging to a set category with reference to file division information combined with the fragment file; and
when the file allowed to be shared is the file belonging to the set category, transmitting a message requesting transmission of remaining fragment files divided from the file allowed to be shared to one or more peer terminals.

7. The method of claim 6, wherein the message requesting the transmission of the remaining fragment files is transmitted according to a Distributed Hash Table (DHT) scheme or a Prefix Hash Table (PHT) scheme.

8. The method of claim 7, further comprising:
after transmitting the message requesting the transmission of the remaining fragment files, receiving position information indicating a position of another terminal storing at least one fragment file among the remaining fragment files, from the at least one peer terminal; and
guiding the position of the another terminal, based on the position information to a user of the terminal.

9. The method of claim 8, further comprising periodically storing the terminal's own position,
wherein guiding the position of the another terminal comprises guiding the position of the another terminal corresponding to the terminal's own past position.

10. The method of claim 6, wherein the file division information includes at least one of identification information of the file allowed to be shared, information on a number of fragment files, information indicating an ordinal number of a corresponding fragment file, and information on a category to which the file allowed to be shared belongs.

11. An apparatus in a terminal for sharing a file with at least one peer terminal in a Peer-to-Peer (P2P) network, the apparatus comprising:
a controller for dividing a file allowed to be shared, generating two or more fragment files, generating file division information used for reconstructing the file allowed to be shared by using the fragment files, and combining the file division information with each of the fragment files; and
a transceiver for transmitting the combined fragment files with the file division information to the at least one peer terminals.

12. The apparatus of claim 11, wherein the file division information includes at least one of identification information of the file allowed to be shared, information on a number of fragment files, and information indicating an ordinal number of a corresponding fragment file.

13. The apparatus of claim 12, wherein the file division information further includes information on a category to which the file allowed to be shared belongs.

14. The apparatus of claim 11, wherein the controller divides the file allowed to be shared based on a number of the at least one peer terminal, and distributes the fragment files to the at least one peer terminal, one by one.

15. An apparatus in a terminal for sharing a file with at least one peer terminal in a Peer-to-Peer (P2P) network, the apparatus comprising:
a transceiver for performing transmission/reception; and
a controller for, when a network is changed after receiving at least one fragment file, which is generated by dividing a file allowed to be shared into two or more fragment files, from a peer terminal, transmitting the received at least one fragment file to the at least one peer terminal located on the changed network.

16. The apparatus of claim 15, wherein the controller determines whether the file allowed to be shared is a file belonging to a set category with reference to file division information combined with the fragment file, and transmits a message requesting transmission of remaining fragment files divided from the file allowed to be shared to the at least one peer terminal, when the file allowed to be shared is the file belonging to the set category.

17. The apparatus of claim 16, wherein the message requesting the transmission of the remaining fragment files is transmitted according to a Distributed Hash Table (DHT) scheme or a Prefix Hash Table (PHT) scheme.

18. The apparatus of claim 17, wherein the controller guides, to a user of the terminal, a position of another terminal based on information on the position of the another terminal storing at least one fragment file from among the remaining fragment files received from the at least one peer terminal.

19. The apparatus of claim 18, wherein the controller periodically stores position of the terminal in a memory, and guides the position of the another terminal corresponding to its own stored past position to the user of the terminal.

20. The apparatus of claim 16, wherein the file division information includes at least one of identification information of the file allowed to be shared, information on a number of fragment files, information indicating an ordinal number of a corresponding fragment file, and information on a category to which the file allowed to be shared belongs.
